(19) United States
(12) Patent Application Publication
(10) Pub. No.: US 2021/0387234 A1
(43) Pub. Date: Dec. 16, 2021

(54) SORTING MACHINE TROLLEY TILTING-PAN MECHANISM

(71) Applicant: GUANGDONG LISHENG INTELLIGENT CO., LTD., DONGGUAN (CN)

(72) Inventors: JIANMAN HUANG, DONGGUAN (CN); ZHIWU HU, DONGGUAN (CN); GAOQIANG ZHANG, DONGGUAN (CN)

(21) Appl. No.: 17/458,616

(22) Filed: Aug. 27, 2021

Related U.S. Application Data
(63) Continuation of application No. PCT/CN2020/072614, filed on Jan. 17, 2020.

(30) Foreign Application Priority Data
Feb. 28, 2019 (CN) 201910148540.7

(51) Int. Cl. B07C 3/08; B65G 47/96

(52) U.S. Cl. CPC B07C 3/08; B65G 47/96

(57) ABSTRACT

The present invention relates to the technical field of automation apparatuses, in particular, to a sorting machine trolley tilting-pan mechanism. A tilting-pan seat, a right seat plate, and a left seat plate are disposed on a rack; the right seat plate and the left seat plate are disposed at two sides of the tilting-pan seat; two short connection rods are movably hinged on the tilting-pan seat; a sliding seat is disposed on both the right seat plate and the left seat plate; a lifting rod is disposed in the middle of the sliding seat; two buffers are further disposed on the sliding seat; the buffers are distributed at two sides of the lifting rod. A tray-typed carrying structure is adopted, so that light and round commodities that are not adaptive for the cross-belt sorting machine to sort can be normally sorted, sorting adaptability is extremely strong, performance is stable.

### TECHNICAL FIELD

The present invention relates to the technical field of automation apparatuses, in particular, to a sorting machine trolley tilting-pan mechanism.

### BACKGROUND

The tilting-pan typed sorting machine can meet high efficiency sorting and delivery requirements in multiple industries; and is controlled by connecting to a Warehouse Control System (WCS) of an entire logistics system. An item to be sorted can be automatically imported through a transmission apparatus or manually imported by an operator into the sorting machine. The sorting machine executes sorting control through control software, and sorts the item to a set outlet, which enters the corresponding transmission container through free falling or through a sliding slot.

The existing sorting machine trolley tilting-pan mechanism has a single design and simple functions. During usage, the following problems would occur: low working efficiency, weak adaptability, hard adjustment, unstable usage, and inconvenient maintenance, thus failing to meet the industrial requirements.

### SUMMARY

The purpose of the present invention is to provide a sorting machine trolley tilting-pan mechanism for the disadvantages in the prior art. The structure thereof is scientifically designed. Upon comparison with a cross-belt sorting machine with the same configuration, an adopted unique “one-trolley-two-pan” structure greatly improves sorting efficiency, and greatly reduces apparatus costs. An adopted tray-typed carrying structure has extremely strong sorting adaptability, stable performance, and convenient usage.

To implement the purpose above, the present invention adopts the following technical solution: A sorting machine trolley tilting-pan mechanism includes a rack, where a tilting-pan seat, a right seat plate, and a left seat plate are disposed on the rack; the right seat plate and the left seat plate are disposed at two sides of the tilting-pan seat; two short connection rods are movably hinged on the tilting-pan seat; a sliding seat is disposed on both the right seat plate and the left seat plate; a lifting rod is disposed in the middle of the sliding seat; two buffers are further disposed on the sliding seat; and the two buffers are symmetrically distributed at two sides of the lifting rod.

The lifting rod is T-shaped; a T-shaped end of the lifting rod is movably hinged with a long connection rod; an end of the long connection rod is movably hinged with the short connection rod; and the long connection rod is provided with a tilting pan.

Two walking wheels are disposed at lower parts of two ends of the rack; two guiding wheels are further disposed at a lower part of a left end of the rack; a joint bearing is disposed at an upper part thereof; and a linear motor secondary plate is further disposed at the left end of the rack.

A rotation shaft and two limiting rods are disposed at lower parts of both the right seat plate and the left seat plate; the two limiting rods are disposed at two sides of the rotation shaft; and a rotation rod is disposed at a lower end of the rotation shaft.

A spring is further disposed at lower ends of the right seat plate and the left seat plate; and the other end of the spring is hinged with the rotation rod.

A locking wheel and a reset wheel are successively disposed at a lower end of the lifting rod from top to bottom; a bearing is disposed both in the middle of the locking wheel and in the middle of the reset wheel; and surfaces thereof are both made of an MC nylon material with lightweight and wear resistance.

The tilting pans at two sides are symmetrically disposed

The walking wheels at the two ends are four universal wheels disposed at equal altitude and in parallel.

The beneficial effects of the present invention are as follows: A sorting machine trolley tilting-pan mechanism includes a rack. A tilting-pan seat, a right seat plate, and a left seat plate are disposed on the rack; the right seat plate and the left seat plate are disposed at two sides of the tilting-pan seat; two short connection rods are movably hinged on the tilting-pan seat; a sliding seat is disposed on both the right seat plate and the left seat plate; a lifting rod is disposed in the middle of the sliding seat; two buffers are further disposed on the sliding seat; the buffers are distributed at two sides of the lifting rod. Upon comparison with a cross-belt sorting machine with the same configuration, an adopted unique “one-trolley-two-pan” structure greatly improves sorting efficiency, and greatly reduces apparatus costs. A tray-typed carrying structure is adopted, so that light and round commodities that are not adaptive for the cross-belt sorting machine to sort can be normally sorted, sorting adaptability is extremely strong, performance is stable, and usage is convenient.

### BRIEF DESCRIPTION OF DRAWINGS

FIG. 1 is a schematic structural diagram of the present invention.

FIG. 2 is a schematic diagram of another implementation of the present invention.

FIG. 3 is a schematic structural diagram of another direction of the present invention.

FIG. 4 is a schematic diagram of an embodiment of the present invention.

### DESCRIPTION OF EMBODIMENTS

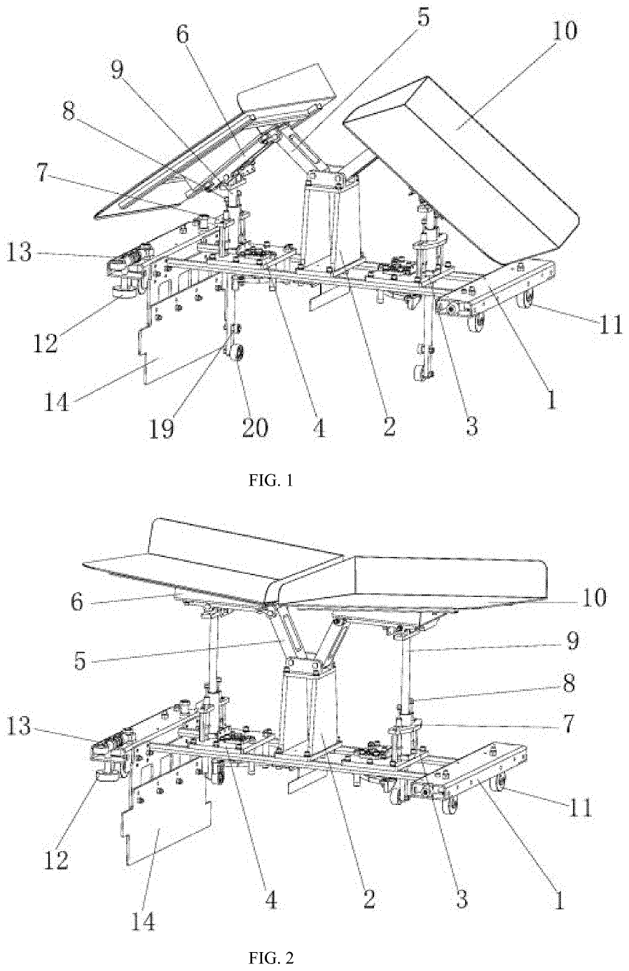

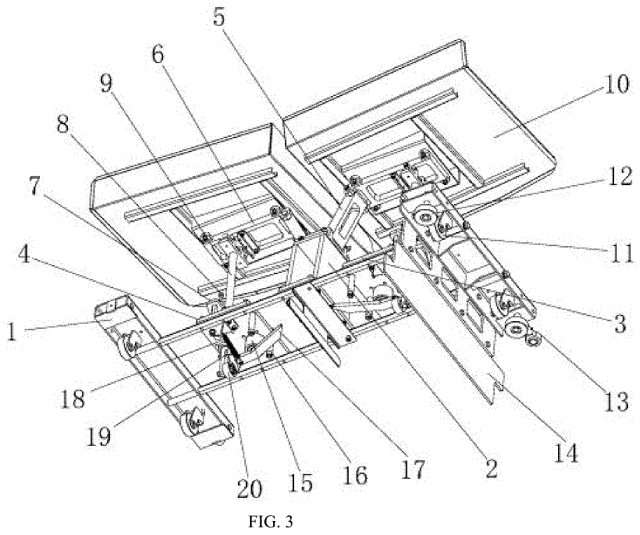

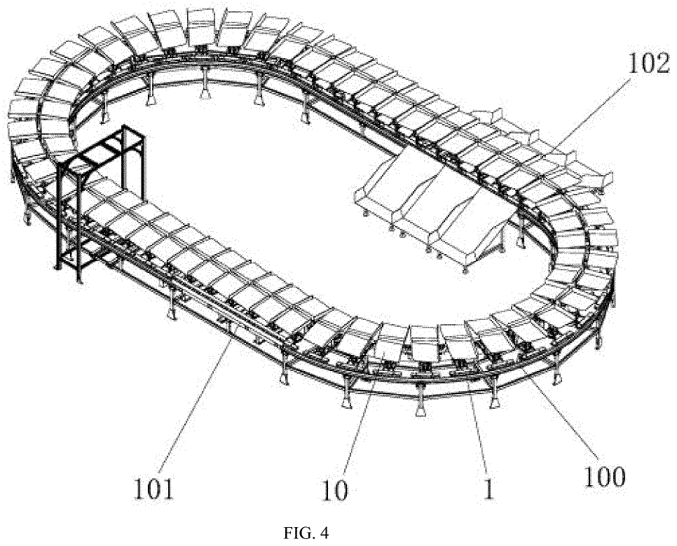

As shown in FIG. 1 to FIG. 4, the present invention includes a rack 1; a tilting-pan seat 2, a right seat plate 3, and a left seat plate 4 are disposed on the rack 1; the right seat plate 3 and the left seat plate 4 are disposed at two sides of the tilting-pan seat 2; two short connection rods 5 are movably hinged on the tilting-pan seat 2; a sliding seat 7 is disposed on both the right seat plate 3 and the left seat plate 4; a lifting rod 9 is disposed in the middle of the sliding seat 7; two buffers 8 are further disposed on the sliding seat 7; the two buffers 8 are symmetrically distributed at two sides of the lifting rod 9; the lifting rod 9 moves up and down along the sliding seat 7; the lifting rod 9 is T-shaped; a T-shaped end of the lifting rod 9 is movably hinged with a long connection rod 6; an end of the long connection rod 6 is movably hinged with the short connection rod 5; the long connection rod 6 is provided with a tilting pan 10; the lifting rod 9 drives the tilting pan 10 to be tilted downward; a T-shaped handle of the lifting rod 9 falls to the buffers 8 so that the tilting pan 10 is free from impacts.

Two walking wheels 12 are disposed at lower parts of two ends of the rack 1; two guiding wheels 11 are further disposed at a lower part of a left end of the rack 1; a joint bearing 13 is disposed at an upper part thereof; and a linear motor secondary plate 14 is further disposed at the left end of the rack 1. The walking wheels 12 can support the entire tilting-pan mechanism to walk; the guiding wheels 11 guide a motion trace of the entire tilting-pan mechanism; the joint bearing 13 can connect a plurality of tilting-pan mechanisms; and the linear motor secondary plate 14 is a power supporting point for the entire tilting-pan mechanism to walk.

A rotation shaft 15 and two limiting rods 16 are disposed at lower parts of both the right seat plate 3 and the left seat plate 4; the two limiting rods 16 are disposed at two sides of the rotation shaft 15; a rotation rod 17 is disposed at a lower end of the rotation shaft 15; the rotation rod 17 is movable on the rotation shaft 15; the two limiting rods 16 limit the moving range of the rotation rod 17; a spring 18 is further disposed at lower parts of the right seat plate 3 and the left seat plate 4; the other end of the spring 18 is hinged with the rotation rod 17; and the spring 18 enables the rotation rod 17 to be pulled back and reset.

A locking wheel 19 and a reset wheel 20 are successively disposed at a lower end of the lifting rod 9 from top to bottom; a bearing is disposed both in the middle of the locking wheel 19 and in the middle of the reset wheel 20; surfaces thereof are both made of an MC nylon material with lightweight and wear resistance, thereby achieving the effects of lightweight and wear resistance. The reset wheel 20 can enable the lifting rod 9 to drive and lift the tilting pan 10. When the locking wheel 19 is lifted up to be higher than the rotation rod 17, the rotation rod 17 rebounds and blocks the locking wheel 19, and the position of the tilting pan 10 is locked.

The tilting pans 10 on both sides are symmetrically disposed, thereby ensuring action harmony of the tilting pans 10 at both sides, and improving working efficiency and stability.

The walking wheels 12 at the two ends are four universal wheels disposed at equal altitude and in parallel, so as to enable the entire tilting-pan mechanism thereof to automatically and stably walk on the operation track, and to smoothly pass through an arc-shaped track during turning, thereby improving automation performance.

The guiding wheel 11 and walking wheel 12 are injection molded using high-performance modified thermoplastic polyurethane and high-quality deep groove ball bearings. Hydrolytic resistance components are added to polyurethane; upon comparison, it may reach twice of the service life of conventional polyurethane materials. The conventional polyurethane likely loses efficacy in a humid environment; a hydrolysis-resistant material can effectively solve this problem. Moreover, the hydrolysis-resistant material has anti-static property, anti-impact resistance property and excellent wear resistance.

The present invention is an important technical module in an automatic sorting apparatus and is mounted on a ring-shaped track 100 of the automatic sorting apparatus for usage. The ring-shaped track 100 is provided with a reset track 101 and an unloading track 102. The tilting-pan trolley is driven by a linear motor on the ring-shaped track 100. The tilting-pan trolleys are head-to-tail connected through a joint bearing 13 to form a closed ring. An item is placed on the tilting pan 10 manually or through an automatic package supply device. An identification code of the item is read through the code reading device 4 to obtain gird mouth information. The tilting-pan trolley 3 reaches a position of a corresponding sorting sliding slot; the tilting pan 10 of the tilting-pan trolley is tilted, and the item falls into the sorting sliding slot along the tilting pan 10 under the function of gravity, to complete sorting.

The operation mode: an initial position of the tilting pan 10 is horizontally titled; the lifting rod 9 lifts up. The locking wheel 19 is clamped on the rotation rod 17. Due to a tensile force of the spring 18 and blocking of the limiting rod 16, the rotation rod 17 enables the locking wheel to lock the lifting rod 9 to avoid falling. When the linear motor carries the sorting machine trolley tilting-pan mechanism to walk to the unloading track 102, the corresponding unloading air cylinder on the unloading track 102 drives the unloading wheel to be pushed out, so that the unloading wheel and the rotation rod are coplanar. When the sorting machine trolley tilting-pan mechanism continues to walk, the unloading wheel blocks an end of the rotation rod 17. The rotation rod 17 rotates on the rotation shaft 15 upon the blocking, and the other end thereof moves out of the position of the locking wheel 19. The weight of the tilting pan 10 plus the weight of the commodity presses the lifting rod 9 thereof downward, and the commodity falls along the tilting pan 10. When the linear motor carries the sorting machine trolley tilting-pan mechanism to continuously walk to the reset track 101, the reset wheel 20 at the lower end of the lifting rod 9 drives along a slope of the reset track, so that the lifting rod 9 thereof lifts up. When the locking wheel 19 is lifted up to be higher than the rotation rod 17, the rotation rod 17 lock the height of the rotation rod 9 again upon the tensile force of the spring 18 thereof, and the tilting pan is horizontally tilted again.

The apparatus is applicable to the following industries: shoes and clothing, books and periodicals, e-commerce, medicine, daily consumer goods and other small parcels application industries. Sortable item types include: small items, irregular shape items, and soft packaging items.

Apparatus performance: A tray-typed carrying structure is adopted, so that light and round commodities that are not adaptive for the cross-belt sorting machine to sort can be normally sorted, and the sorting adaptability is extremely strong.

The sorting efficiency of an adopted unique “one-trolley-two-pan” structure is twice as high as that of a cross-belt sorting machine with the same configuration, and when the main ring speed is 1.2 m/s, the sorting efficiency may reach 15400 pieces per hour. If a double-end package supply configuration is adopted, the maximum theoretical processing efficiency may reach 30800 pieces per hour.

The apparatus is operated in a low rate, which is more suitable for a manual package supply mode and does not require multi-stage package supply systems. At the same time, a mouth sliding slot and a track door frame are integrally designed, and thus the system has a compact structure and a flexible arrangement, reduces occupation of land, and reduces costs.

The linear motor is adopted for driving main line operation, and a pure mechanical structure design is adopted for a sorting bogie unloading and reset mechanism; and the whole set of apparatuses is extremely low in energy consumption.

When the tilting-pan typed sorting machine is used for unloading, the commodity inclinedly falls into the sliding slot along the tilting pan, the sorting is stable, and the commodity would not be easily damaged.

The aforementioned are only preferable embodiments of the present invention, and therefore, all equivalent variations or modifications made according to the constructions, features, and principles in the patent application scope of the present invention are included in the patent application scope of the present invention.

What is claimed is:

1. A sorting machine trolley tilting-pan mechanism, comprising a rack (1), wherein a tilting-pan seat (2), a right seat plate (3), and a left seat plate (4) are disposed on the rack (1); the right seat plate (3) and the left seat plate (4) are disposed at two sides of the tilting-pan seat (2); two short connection rods (5) are movably hinged on the tilting-pan seat (2); a sliding seat (7) is disposed on both the right seat plate (3) and the left seat plate (4); a lifting rod (9) is disposed in the middle of the sliding seat (7); two buffers (8) are further disposed on the sliding seat (7); the two buffers (8) are symmetrically distributed at two sides of the lifting rod (9); a rotation shaft (15) and two limiting rods (16) are disposed at lower parts of both the right seat plate (3) and the left seat plate (4); the two limiting rods (16) are disposed at two sides of the rotation shaft (15); and a rotation rod (17) is disposed at a lower end of the rotation shaft (15).

2. The sorting machine trolley tilting-pan mechanism according to claim 1, wherein the lifting rod (9) is T-shaped; a T-shaped end of the lifting rod (9) is movably hinged with a long connection rod (6); an end of the long connection rod (6) is movably hinged with the short connection rod (5); and the long connection rod (6) is provided with a tilting pan (10).

3. The sorting machine trolley tilting-pan mechanism according to claim 2, wherein two walking wheels (12) are disposed at lower parts of two ends of the rack (1); two guiding wheels (11) are further disposed at a lower part of a left end of the rack (1); a joint bearing (13) is disposed at an upper part thereof; and a linear motor secondary plate (14) is further disposed at the left end of the rack (1).

4. The sorting machine trolley tilting-pan mechanism according to claim 1, wherein a spring (18) is further disposed at lower ends of the right seat plate (3) and the left seat plate (4); and the other end of the spring (18) is hinged with the rotation rod (17).

5. The sorting machine trolley tilting-pan mechanism according to claim 1, wherein a locking wheel (19) and a reset wheel (20) are successively disposed at a lower end of the lifting rod (9) from top to bottom; a bearing is disposed both in the middle of the locking wheel (19) and in the middle of the reset wheel (20); and surfaces thereof are both made of an MC nylon material with lightweight and wear resistance.

6. The sorting machine trolley tilting-pan mechanism according to claim 2, wherein the tilting pans (10) are disposed in a symmetrical pair.

7. The sorting machine trolley tilting-pan mechanism according to claim 1, wherein the walking wheels (12) at the two ends are four universal wheels disposed at equal altitude and in parallel.
